(19) United States
(12) Patent Application Publication
(10) Pub. No.: US 2020/0387477 A1
(43) Pub. Date: Dec. 10, 2020

(54) STORAGE SYSTEM AND SNAPSHOT MANAGEMENT METHOD

(71) Applicant: Hitachi, Ltd., Tokyo (JP)

(72) Inventors: Yusuke Yamaga, Tokyo (JP); Takaki Matsushita, Tokyo (JP); Tomohiro Kawaguchi, Tokyo (JP)

(73) Assignee: Hitachi, Ltd., Tokyo (JP)

(21) Appl. No.: 16/800,610

(22) Filed: Feb. 25, 2020

(30) Foreign Application Priority Data
Jun. 10, 2019 (JP) 2019-107928

(51) Int. Cl. G06F 16/11

(52) U.S. Cl. CPC G06F 16/128

(57) ABSTRACT

The present invention provides a storage that enables all of a plurality of users to exercise snapshot management without causing a problem even in a situation where the plurality of users acquire snapshots of the same primary volume.

Snapshots created through a plurality of interfaces are grouped. Grouping is performed at the time of snapshot creation. Snapshots in a group are required by other interfaces at a time when the snapshots are created. In a case where a deletion instruction is issued with respect to grouped snapshots, only the issuance of the deletion instruction is recorded without deleting snapshot data. In a case where the deletion instruction is issued with respect to all the snapshots in a group, the group is deleted because the snapshots in the group can be determined to be unnecessary for any user. After group deletion, snapshots instructed to be deleted and not grouped are deleted.

### BACKGROUND OF THE INVENTION

### 1. Field of the Invention

The present invention relates to a storage system, and more particularly to a technology suitable for snapshot management.

### 2. Description of the Related Art

In a storage system, primary volume data is backed up. Data to be used for processing by a host is written into the primary data. A known backup method, for example, manages a snapshot of a state of a volume at a predetermined time point. Data representing a snapshot is recorded in a primary volume or in a pool. The pool is a logical storage hierarchy layer that is lower by one level than a volume.

When a primary volume is write-accessed after an instruction for snapshot creation, data in a write-destination region of the primary volume is saved in a pool in order to retain data at a predetermined time point. When the data in the primary volume is broken, a storage administrator restores the data in the primary volume by performing a restore process such that snapshot data saved in the pool is reflected in the primary volume.

Further, in recent years, snapshots are not only used for backup use cases, but also used for secondary data use cases. In the secondary data use cases, it is conceivable that a primary volume is used for a core system while a secondary volume, which is a duplicate of the primary volume, is used for data analysis, development, and testing purposes. The secondary volume references a snapshot of the primary volume at a predetermined time point. In the secondary data use cases, a snapshot function of a storage device is frequently used from an application running on a host by an application developer or a user and not by the storage administrator. Meanwhile, in the backup use cases, a snapshot is mostly created by the storage administrator on a periodic basis as in the past. Therefore, in multiple use cases, a snapshot is increasingly used together by a plurality of users.

A storage system having a snapshot function is described in JP-2014-507693T.

### SUMMARY OF THE INVENTION

The storage system described in JP-2014-507693T makes it possible to back up a volume at a predetermined time point by executing the snapshot function.

However, in some cases where a plurality of users use the snapshot function with respect to the same primary volume, a state where consistency between snapshot management information and snapshot data may not be restored. If, for example, user 1 deletes an unnecessary snapshot, and then user 2 performs a restore process at a time point not recognized by an application used by user 1, the application used by user 1 returns to a previous state restored by user 2. The restored data includes the snapshot management information for managing the deleted snapshot. Therefore, the application of user 1 recognizes that the deleted snapshot exists. However, that snapshot is already deleted and cannot be operated. The reason is that the snapshot management information needs to be accessed from the application used by user 1 for operating the snapshot. Thus, it is necessary to store the snapshot management information in a volume as is the case with normal write data. Accordingly, the reason is that, when user 2 acquires a snapshot, the snapshot management information acquired by user 1 is included in the snapshot acquired by user 2.

JP-2014-507693T describes the snapshot function, but does not describe a problem arising when a plurality of users acquire the snapshot of one volume.

In view of the above circumstances, the present invention provides a storage system and a snapshot management method that enable all of a plurality of users to manage snapshots without causing a problem even in a situation where the plurality of users acquire snapshots of the same primary volume.

In order to address the above-described problem and other problems, according to an aspect of the present invention, there is provided a storage system including a storage device and a controller. The controller includes a first interface, a second interface, and a memory. The first interface is connected to a server system that issues an IO request to the storage system. The second interface is connected to a management system that manages the storage system. The memory provides the server system with a volume that is to be configured by using a storage device. Upon receiving a snapshot acquisition instruction on the volume from one of the first and second interfaces, the memory stores attribute information and status information with respect to a snapshot to be acquired. The attribute information indicates whether the snapshot acquisition instruction is received through the first interface or the second interface. The status information indicates that an acquired snapshot is in a state where a deletion instruction is not issued yet.

The present invention makes it possible to provide a storage system that enables each of a plurality of users to use a snapshot function without affecting snapshot operations of the other users even when the plurality of the users use the snapshot function with respect to the same primary volume.

### BRIEF DESCRIPTION OF THE DRAWINGS

FIG. 1 is a diagram illustrating an example configuration of a system including a storage system according to a first embodiment of the present invention;

FIG. 2 is a diagram illustrating the relationship between a primary volume and secondary volumes in accordance with the first embodiment;

FIG. 3 is a diagram illustrating a recording hierarchy according to the first embodiment;

FIG. 4A is a diagram illustrating a snapshot acquisition operation that is performed by an administrator in accordance with the first embodiment;

FIG. 4B is a diagram illustrating snapshot acquisition and snapshot deletion operations that are performed by the administrator in accordance with the first embodiment;

FIG. 4C is a diagram illustrating a snapshot acquisition operation that is performed by the administrator in accordance with the first embodiment;

FIG. 4D is a conceptual diagram illustrating snapshot management information according to the first embodiment;

FIG. 5 is a diagram illustrating an example configuration of a memory according to the first embodiment and examples of programs and management information in the memory;

FIG. 6 is a diagram illustrating an example of a pair management table according to the first embodiment;

FIG. 7 is a diagram illustrating an example of a difference region management table;

FIG. 8 is a diagram illustrating an example of an address management table according to the first embodiment;

FIG. 9 is a diagram illustrating an example of a page management table according to the first embodiment;

FIG. 10 is a flowchart illustrating an example of a snapshot creation process according to the first embodiment;

FIG. 11 is a flowchart illustrating an example of a grouping process according to the first embodiment;

FIG. 12 is a flowchart illustrating an example of a snapshot deletion process according to the first embodiment;

FIG. 13 is a flowchart illustrating an example of a designated-snapshot deletion process according to the first embodiment;

FIG. 14 is a flowchart illustrating an example of a group deletion process according to the first embodiment;

FIG. 15 is a flowchart illustrating an example of a restore process according to the first embodiment;

FIG. 16 is a flowchart illustrating an example of a restore determination process according to the first embodiment;

FIG. 17 is a conceptual diagram illustrating a snapshot processing method for a restore according to the first embodiment;

FIG. 18 is a diagram illustrating an example of the first embodiment of the present invention;

FIG. 19 is a diagram illustrating an example configuration of the memory according to a second embodiment of the present invention and examples of programs and management information in the memory;

FIG. 20 is a flowchart illustrating an example of a post-restore process according to the second embodiment; and

FIG. 21 is a diagram illustrating an operational concept of the post-restore process according to the second embodiment.

### DESCRIPTION OF THE PREFERRED EMBODIMENTS

An “interface section” in the following description may be one or more interfaces. The one or more interfaces may be one or more communication interface devices of the same type (e.g., one or more network interface cards (NICs) or two or more communication interface devices of different types (e.g., a network interface card (NIC) and a host bus adapter (HBA)).

A “memory section” in the following description may be one or more memories and may typically be a main storage device. At least one memory in the memory section may be a volatile memory or a nonvolatile memory.

A “PDEV section” in the following description may be one or more PDEVs and may typically be an auxiliary storage device. The term “PDEV” denotes a physical storage device, and is typically a nonvolatile storage device such as a hard disk drive (HDD) or a solid-state drive (SSD).

A “storage section” in the following description is at least one of the memory section and the PDEV section (typically, at least the memory section).

A “processor section” in the following description is one or more processors. At least one processor is typically a microprocessor such as a central processing unit (CPU), but may alternatively be a processor of a different kind such as a graphics processing unit (GPU). At least one processor may be a single-core processor or a multi-core processor.

At least one processor may be a processor in a broad sense such as a hardware circuit that performs some or all of processes (e.g., a field-programmable gate array (FPGA) or an application-specific integrated circuit (ASIC)).

The following description occasionally deals with information the output of which is obtained in response to an input by using the expression “xxx table.” However, the information may be data having any structure or a learning model such as a neural network that generates an output in response to an input. Therefore, the “xxx table” may be referred to as “xxx information.”

In the following description, a configuration of each table is merely an example. One table may be divided into two or more tables, or all or some of two or more tables may form one table.

The following description occasionally deals with a process by using a “program” as a subject. However, when executed by a processor section, the program performs a predetermined process while using, for example, a storage section and/or an interface section. Therefore, the subject of a process may be regarded as the processor section (or a controller or other device having the processor section).

Programs may be installed on a device such as a computer or recorded, for example, on a recording medium (e.g., a non-transitory recording medium) that can be read by a program distribution server or a computer. In the following description, two or more programs may be implemented as one program, and one program may be implemented as two or more programs.

A “computer system” in the following description is a system including one or more physical computers. The physical computers may be either general-purpose computers or special-purpose computers. The physical computers may function as a computer (e.g., a host computer) that issues input/output (I/O) requestor function as a computer (e.g., a storage device) that inputs and outputs data in response to the I/O requests.

Stated differently, the computer system may be at least one of a host system including one or more host computers for issuing I/O requests and a storage system including one or more storage devices for inputting and outputting data in response to the I/O requests. One or more virtual computers (e.g., virtual machines (VMs)) may be executed in at least one physical computer. The virtual computers may be a computer for issuing I/O requests or a computer for inputting and outputting data in response to the I/O requests.

The computer system may be a distributed system including one or more (typically, a plurality of) physical node devices. The physical node devices are physical computers.

A physical computer (e.g., a node device) may be allowed to execute predetermined software in order to build software-defined anything (SDx) in the physical computer or a computer system including the physical computer. For example, a software-defined storage (SDS) or a software-defined data center (SDDC) may be adopted as SDx.

For example, a storage system acting as an SDS may be built by allowing a physical general-purpose computer to execute software having a storage function.

At least one physical computer (e.g., a storage device) may execute one or more virtual computers acting as a host system, and execute a virtual computer acting as a storage controller (typically, a device for inputting and outputting data to the PDEV section in response to an I/O request) of a storage system.

Stated differently, the aforementioned at least one physical computer may have at least some functions of the host system in addition to at least some functions of the storage system.

The computer system (typically, the storage system) may include a redundancy configuration group. A redundancy configuration may be configured as a plurality of node devices, such as Erasure Coding devices, a Redundant Array of Independent Nodes (RAIN), or inter-node mirroring devices, or may be configured as a single computer (e.g., a node device) such as a group of one or more Redundant Arrays of Independent (or Inexpensive) Disks (RAIDs) acting as at least a part of the PDEV section.

A “data set” in the following description is a chunk of logical electronic data as viewed from a program such as an application program, and may be, for example, a record, a file, or a key-value pair.

In the following description, an identification number is used as identification information on various targets. However, identification information other than an identification number (e.g., an identifier including alphabetical characters and symbols) may alternatively be adopted.

In the following description, a reference sign (or a common sign included in the reference sign) may be used in a case where elements of the same type are not differentiated from each other, and identification numbers of elements (or reference signs) may be used in a case where elements of the same type are differentiated from each other.

In a case where, for example, a secondary volume represented by “SVOL” is described without any differentiation, it may be designated as “SVOL501.” In a case where individual pages are differentiated from each other for description purposes, they may be designated, for example, as “SVOL #0” and “SVOL #1” by using SVOL generation numbers or may be designated, for example, as “SVOL 501a” and “SVOL 501b” by using reference numerals.

### First Embodiment

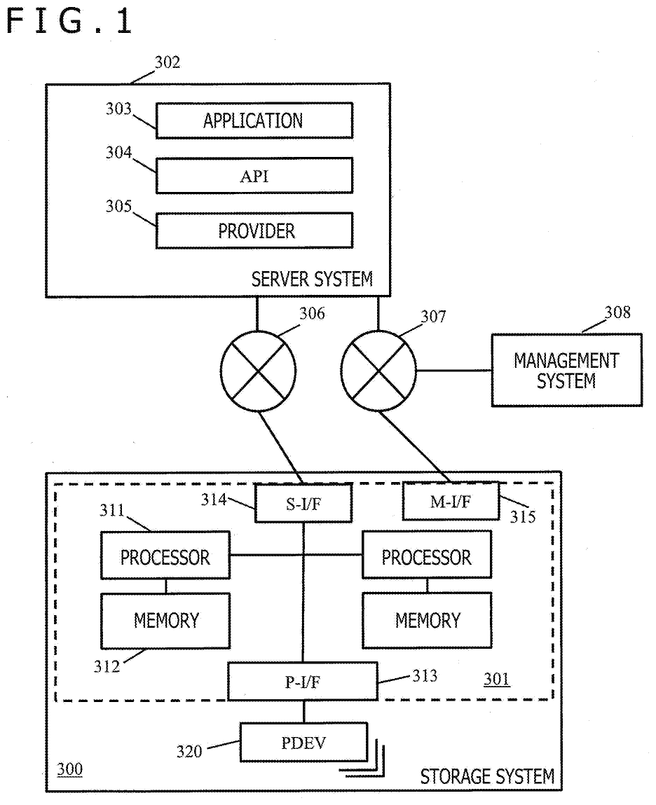

A first embodiment of the present invention will now be described with reference to FIGS. 1 to 18.

FIG. 1 is a diagram illustrating an example configuration of a system including a storage system 300. The storage system 300 includes one or more PDEVs 320 and a storage controller 301. The PDEVs 320 each include a storage device. The storage controller 301 is connected to the PDEVs 320.

The storage controller 301 includes an S-I/F 314, an M-I/F 315, a P-I/F 313, a memory 312, and a processor 311. The S-I/F 314, an M-I/F 315, and the P-I/F 313 are examples of the interface section. The memory 312 is an example of the storage section.

The S-I/F 314 is a communication interface device that mediates data between a server system 302 and the storage controller 301. The S-I/F 314 is connected to the server system 302 through a Fibre Channel (FC) network 306.

The server system 302 transmits, to the storage controller 301, a logical volume number, such as an I/O destination (e.g., a logical unit number (LUN)), and an I/O request (a write request or a read request) designating a logical block address (LBA) or other logical address.

The M-I/F 315 is a communication interface device that mediates data between a management system 308 and the storage controller 301 and between the server system 302 and the storage controller 301. The M-I/F 315 is connected to the management system 308 and the server system 302 through an Internet Protocol (IP) network 307.

The network 306 and the network 307 may be communication networks identical to each other. An application 303 running on the server system 302 transmits a request for creating or deleting a snapshot to the storage controller 301 through an application programming interface (API) 304 and a provider 305 supplied from a storage vendor, and manages a created generation number (#).

The management system 308 manages the storage system 300. The management system 308 also transmits a request for creating or deleting a snapshot to the storage controller 301, and manages a created generation number (#).

The P-I/F 313 is a communication interface device that mediates data between a plurality of PDEVs 320 and the storage controller 301. The P-I/F 313 is connected to one or more PDEVS 320.

The memory 312 stores a program that is to be executed by the processor 311, and stores data that is to be used by the processor 311. The processor 311 executes a program stored in the memory 312. In the first embodiment, for example, a set of memory 312 and processor 311 is duplexed.

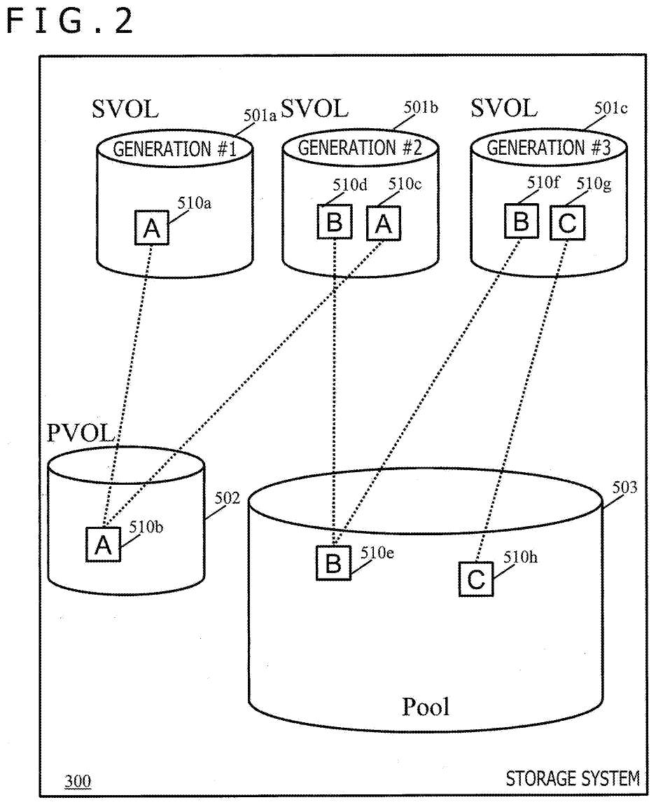

FIG. 2 is a diagram illustrating the relationship between a primary volume and secondary volumes in the storage system 300. The primary volume (PVOL) 502 is a volume into which data to be used by the server system 302 for processing purposes is written. The PVOL 502 may be a substantial logical volume based on a RAID (Redundant Array of Independent (or Inexpensive) Disks) group including a plurality of disk devices (a group of disk devices storing data at a predetermined RAID level), or may be a virtual logical volume not based on the RAID group (e.g., a thin-provisioned volume or a volume to which storage resources of an external storage device (e.g., logical volumes) are mapped).

Meanwhile, each of the secondary volumes (SVOLs) 501 stores a snapshot at the time of snapshot acquisition with respect to the PVOL 502. The SVOLs are virtual logical volumes. Data stored in the SVOLs 501 are actually stored in the PVOL 502 or in a pool 503. In the first embodiment, the SVOLs 501 are configured such that their generation numbers (generation #) indicate the order of acquisition of relevant snapshots. From the oldest to the newest, their generations are designated as generation #1, generation #2, generation #3, and so on. The older the generation, the lower the generation number.

A region 510a in an SVOL 501a of generation #1 and a region 510c in an SVOL 501b of generation #2 are set up so as to reference a region 510b in the PVOL. A region 510g in an SVOL 501c of generation #3 is set up so as to reference a region 510h in the pool 503, which stores data saved from a region updated between generation #2 and generation #3 (a region in the PVOL 502). A region 510d in the SVOL 501b of generation #2 and a region 510f in the SVOL 501c of generation #3, which correspond to a region updated between generation #1 and generation #2 and not updated between generation #2 and generation #3 (a region in the PVOL 502), are set up so as to reference a region 510e in the pool 503, which stores data saved from a region updated between generation #1 and generation #2 (a region in the PVOL 502).

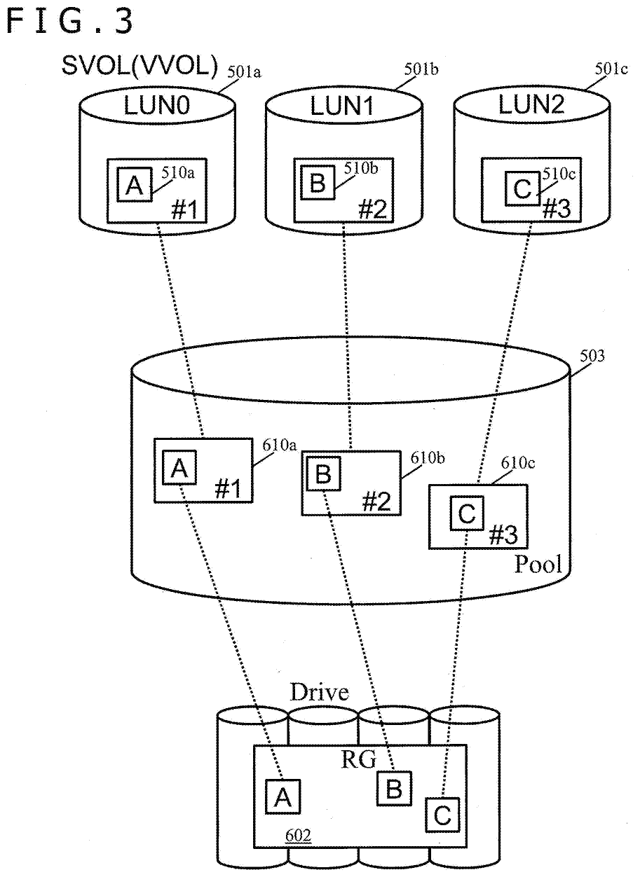

FIG. 3 illustrates a storage hierarchy in the storage system 300. In the following description, the nth layer of the storage hierarchy is referred to as “layer n” (n is a natural number). The smaller the number n, the higher the layer. The layers of the storage hierarchy are the SVOL 501, the pool 503, and an RG 602.

The SVOL 501 is a logical storage region of layer 1 and the aforementioned logical volume (visible from the server system 302) to be supplied to the server system 302.

The pool 503 is a logical storage region of layer 2 and a logical storage region based on one or more RGs 602. The pool 503 includes a plurality of pages 610. A part or the whole of the pool 503 may be based on storage resources outside of the storage system 300 instead of or in addition to at least one RG 602.

The RG 602 is a logical storage region of layer 3 and a space in a RAID group including a plurality of PDEVs 320.

As regards the SVOL 501, the pages 610 of the pool 503 are assigned to a region where data is to be actually stored.

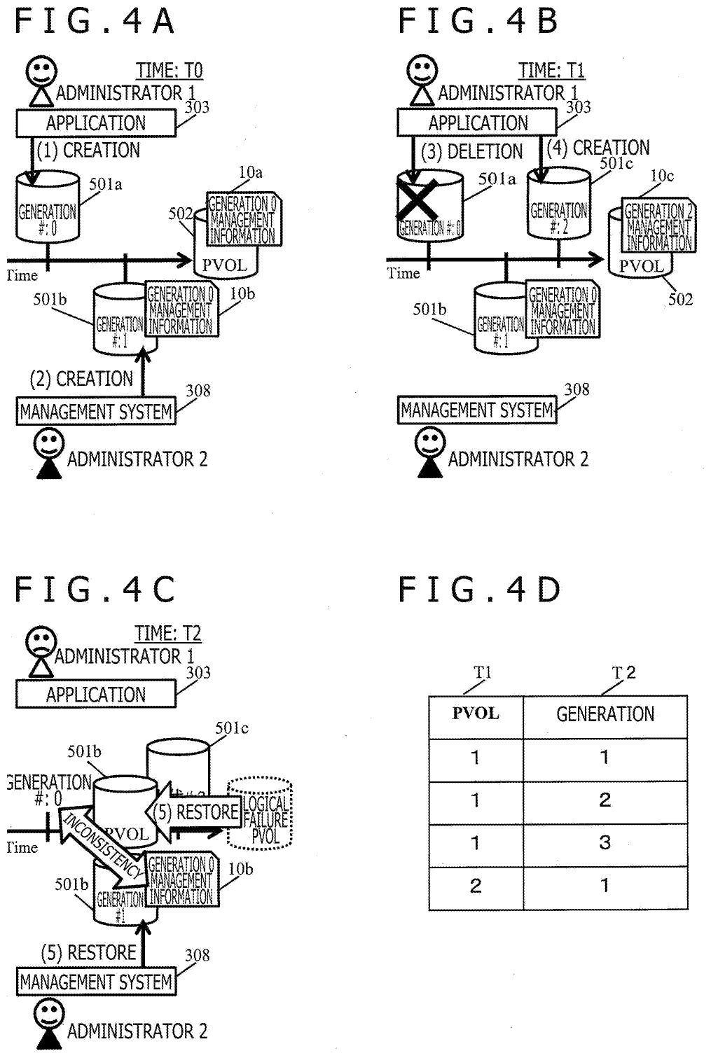

FIGS. 4A to 4C are diagrams illustrating a snapshot acquisition operation performed by an administrator. FIG. 4D is a diagram illustrating snapshot management information. FIGS. 4A to 4D will now be used to describe a problem that needs to be addressed.

As depicted in FIG. 4A, administrator 1 is a user who causes the application 303 in the server system 302, which is described in conjunction with FIG. 1, to instruct the storage controller 301 in the storage system 300 to create a snapshot. Administrator 1 transmits a snapshot creation instruction from the server system 302. Information regarding the execution of operations, such as snapshot creation and deletion, and information regarding, for example, the number of snapshots are recorded as snapshot management information 10 (hereinafter referred to as the SS management information) so that such information is accessible from the application 303.

As depicted in FIG. 4D, the SS management information is managed in such a manner that the generation number T2 of a snapshot correlates with the PVOL T1. The generation number T2 may be, for example, the date and time of snapshot acquisition or other information that uniquely identifies the PVOL generation of each snapshot.

Meanwhile, administrator 2 is an administrator of the storage system 300, and transmits a snapshot creation instruction from the management system 308 to the storage controller 301. Management information on a snapshot acquired by administrator 2 through the use of the management system 308 is stored in the memory 312 (shared memory) within the storage system 300.

When administrator 1 issues a snapshot creation instruction from the application 303 at time T0, the SVOL 501a, which is a snapshot of generation #0. When an update request is issued to the PVOL 502, a snapshot 501a stores old data. After completion of snapshot creation, the application 303 records SS management information 10a of generation #0 in the PVOL 502. In general, snapshot management information is stored in the memory 312 of the storage system. However, the application 303 is unable to access the snapshot management information stored in the memory 312. Therefore, SS management information 10 is written in the PVOL 502, which is accessible. As depicted in FIG. 4D, the SS management information 10 is managed in such a manner that PVOL identification information T1 correlates with generation information T2 on a snapshot with respect to the PVOL. The generation information may be indicative of time at which a snapshot is acquired.

Subsequently, when administrator 2 issues a snapshot creation instruction from the management system 308, the SVOL 501b, which is a snapshot of generation #1, is created. The SVOL 501b includes the SS management information 10 stored in the PVOL 502.

When, at time T1, administrator 1 deletes a snapshot of generation #0 from the application 303 as depicted in FIG. 4B, a snapshot 501a of generation #0 is deleted. Subsequently, when a snapshot creation instruction is issued with respect to a snapshot of generation #2, the snapshot of generation #2 and the SVOL 501c are created. At this time, SS management information 10c on generation #2 is stored so that the SS management information on a snapshot of generation #2 can be read from the application 303.

In a case where administrator 2 performs a restore process at time T2 from the management system 308 in order to restore to generation #1, as depicted in FIG. 4C, a snapshot 501b including the SS management information of generation #0 is restored. In reality, however, generation #0 (501a) is deleted so as to lose consistency with SS management information 10b of generation #1. This causes a problem where administrator 1 is unable to continuously perform a snapshot operation from the application 303.

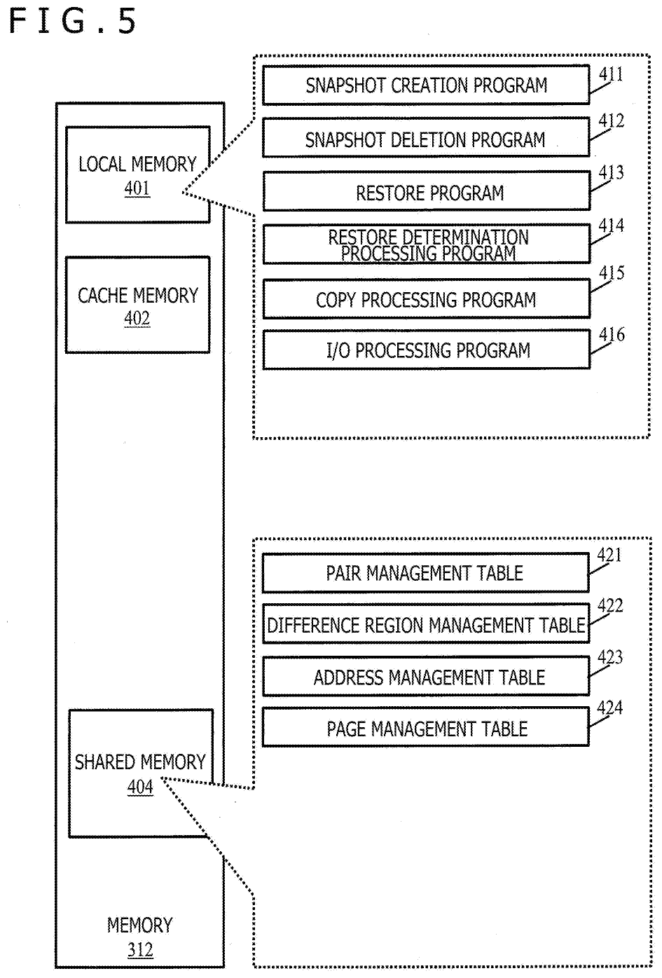

FIGS. 5 to 18 will now be used to describe an embodiment for addressing the above-mentioned problem.

FIG. 5 is a diagram illustrating a configuration of the memory 312 and examples of programs and management information in the memory 312. The memory 312 includes memory regions, namely, a local memory 401, a cache memory 402, and a shared memory 404. At least one of the memory regions may be an independent memory. The local memory 401 is used by a processor 311 that belongs to the same set as the memory 312 including the local memory 401.

The local memory 401 stores a snapshot creation program 411, a snapshot deletion program 412, a restore program 413, a restore determination processing program 414, a copy processing program 415, and an I/O processing program 416. The snapshot creation program 411, the snapshot deletion program 412, the restore program 413, and the restore determination processing program 414 will be described later.

The copy processing program 415 performs a copy process on data. The I/O processing program 416 calls another program as needed and performs an input/output process on data. These two programs will not be described in detail because they are the same as those described in JP-2014-507693T.

The cache memory 402 temporarily stores a data set that is to be written into or read from the PDEVs 320.

The shared memory 404 is used by both a processor 311 belonging to the same set as the memory 312 including the shared memory 404 and a processor 311 belonging to a different set. The shared memory 404 stores management information.

The management information includes a pair management table 421, a difference region management table 422, an address management table 423, and a page management table 424. These tables will be described later with reference to the accompanying drawings.

Some of the tables are described below.

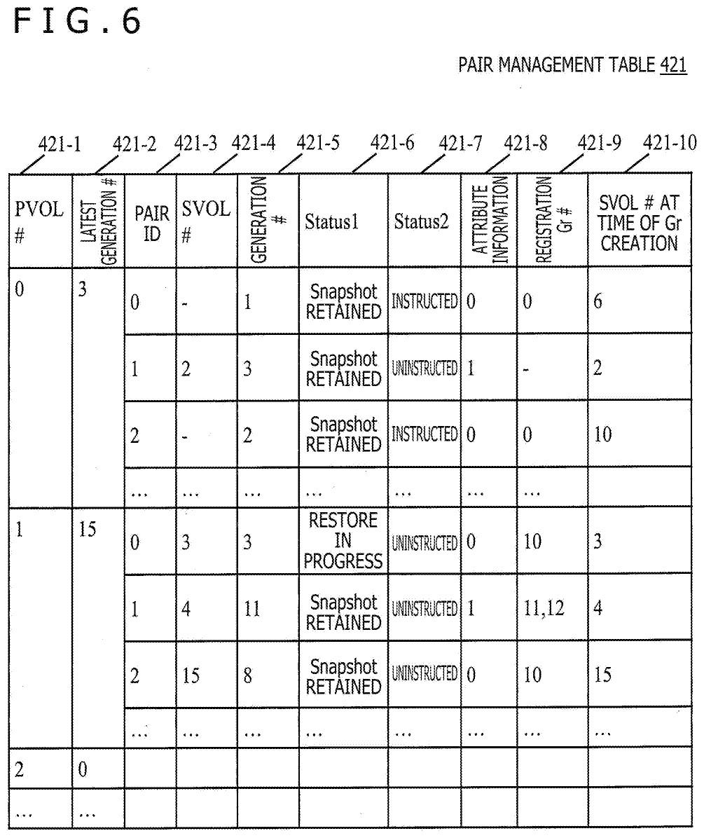

FIG. 6 is a diagram illustrating the pair management table 421, which manages pair information on a PVOL. In the following description, a logical volume is referred to a “VOL” as needed.

The pair management table 421 manages records that are associated with a PVOL number (PVOL #) 421-1, a latest generation number (latest generation #) 421-2, a pair ID 421-3, an SVOL number (SVOL #) 421-4, a generation number (generation #) 421-5, two statuses 421-6, 421-7, an attribute information 421-8, a registration group number (registration Gr #) 421-9, and an SVOL number at the time of group creation (SVOL # at the time of Gr creation) 421-10. The pair ID 421-3, the SVOL number (SVOL #) 421-4, the generation number (generation #) 421-5, the two statuses 421-6, 421-7, the attribute information 421-8, the registration group number (registration Gr #) 421-9, and the SVOL number at the time of group creation (SVOL # at the time of Gr creation) 421-10 are information regarding an acquired snapshot.

The PVOL #421-1 is a number that uniquely identifies a copy source volume (PVOL) in the storage system 300. The latest generation #421-2 is the generation number of the latest snapshot in the associated PVOL. The pair ID 421-3 is a number that uniquely identifies the pair of a PVOL and a generation. The SVOL #421-4 is a number indicative of a volume (SVOL) for mapping a snapshot of generation #, and is assigned at the time of pair creation. The SVOL #421-4 may be changed by a pair operation.

The generation #421-5 is a number that determines the order of acquisition of PVOL snapshots. Status 1 (421-6) is the state of an associated copy pair. The state may be “snapshot retained” or “restore in progress.” The “snapshot retained” state is a state where a snapshot is retained. The “restore in progress” state is a state where a restore is being performed from an associated snapshot generation.

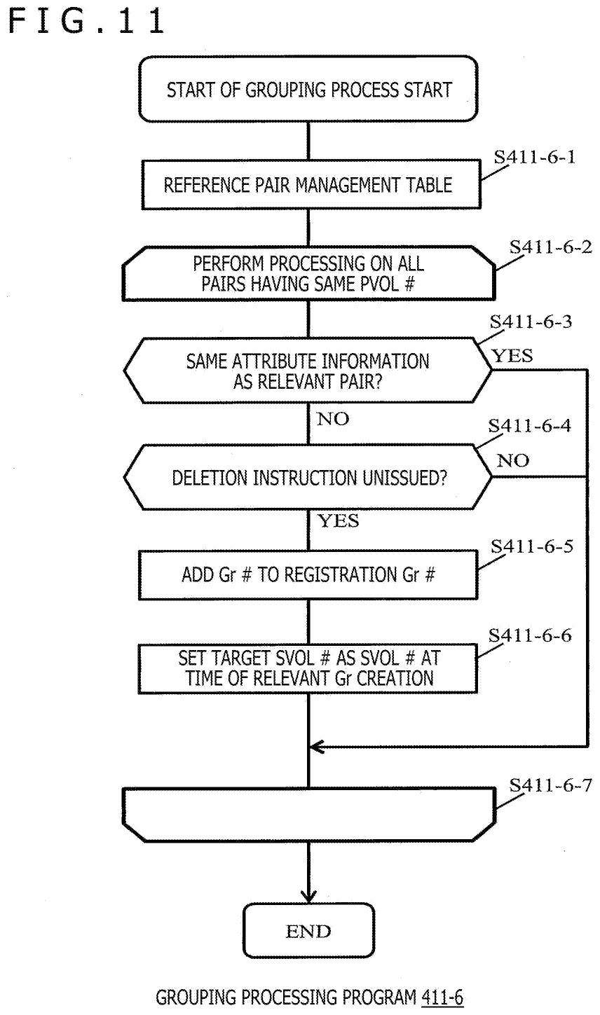

Status 2 (421-7) is the state of a snapshot of the associated generation. The state may be “uninstructed” or “instructed.” The “uninstructed” state is a state where a snapshot deletion instruction is not issued. The “instructed” state is a state where a snapshot deletion instruction is received. The attribute information 421-8 indicates an interface from which a snapshot is created. The registration group number (registration Gr #) 421-9 is a group number associated with a grouping process that is described later with reference to FIG. 11. The group number is assigned at the time of grouping and will not be changed later. The SVOL number at the time of group creation (SVOL # at the time of Gr creation) 421-10 is also an SVOL number at the time of group creation that is recorded in the grouping process described later with reference to FIG. 11.

For example, according to the uppermost record in FIG. 6, a VOL having the VOL #0 is a PVOL, an I/F instruction based on attribute information 0 is used, a snapshot creation instruction is issued to an SVOL having the VOL #6, and the relevant pair ID is 0. The record indicates that a retained snapshot is of generation #1 and registered in group 0. Further, the record currently indicates that a deletion instruction is issued from an I/F based on attribute information 0, and that the SVOL # 421-4 is “−,” and further that a snapshot is invisible from the server system 302.

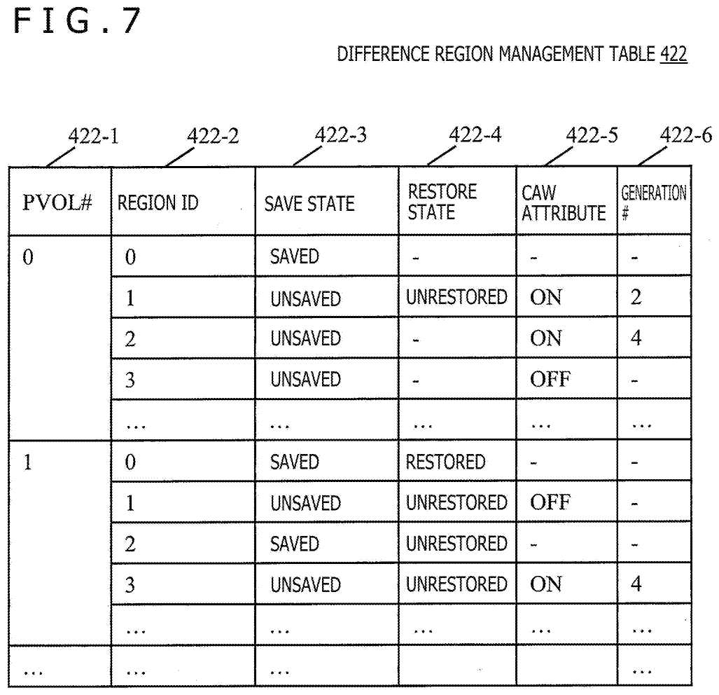

FIG. 7 is a diagram illustrating information on a snapshot with respect to each region of a PVOL. The difference region management table will now be described with reference to FIG. 7.

The difference region management table 422 manages records that are associated with a PVOL number (PVOL #) 422-1, a region ID 422-2, a save state 422-3, a restore state 422-4, a CAW attribute 422-5, and a generation number (generation #) 422-6.

The PVOL #422-1 is a number that uniquely identifies a copy source VOL (PVOL) in the storage system 300. The region ID 422-2 is an example of region identification information and a number identifying a region (slot) demarcated within a PVOL. The save state 422-3 is information indicating whether data to be written into a region in a PVOL is saved in the pool 503. The save state is either a “saved” state or an “unsaved state.” The “saved” state is a state where data is saved. The “unsaved state” is a state where data is not saved.

The restore state 422-4 is information indicating whether a restore is performed. As the restore state, “restored,” which indicates that a restore is done, is set in a case where a restore is performed, and “unrestored” is set in a case where a restore is not performed. The CAW attribute 422-5 is set to “ON” in a case where it is necessary to execute CAW with respect to a relevant region, that is, data needs to be backup-copied from an associated PVOL region, and set to “OFF” in a case where it is not necessary to execute CAW, that is, data need not be saved from a PVOL region.

The generation #422-6 is a generation number of a snapshot that is associated with data to be written into a relevant region (data (data element) in the cache memory 402). In the first embodiment, a number obtained by adding the number 1 to the latest generation # of a snapshot when it is written is set as the generation # of a data element written subsequently to the time of the latest snapshot acquisition. Here, this generation number is an example of temporal relationship information indicative of the temporal relationship between a PVOL and a point of snapshot acquisition time. The snapshot acquisition time may be managed instead of the generation #. In short, it is essential that the generation # serve as information for grasping the temporal relationship between a data element and a point of snapshot acquisition time, that is, determining, for example, whether they coincide with each other or which is earlier than the other.

For example, the second record in FIG. 7, indicates that, in a region having the region #1 in a VOL having the VOL #0, a data element is unsaved and a restore is not performed, and that CAW is executed in a case where data is to be written into the region, and further that data in the region is a snapshot of generation #2.

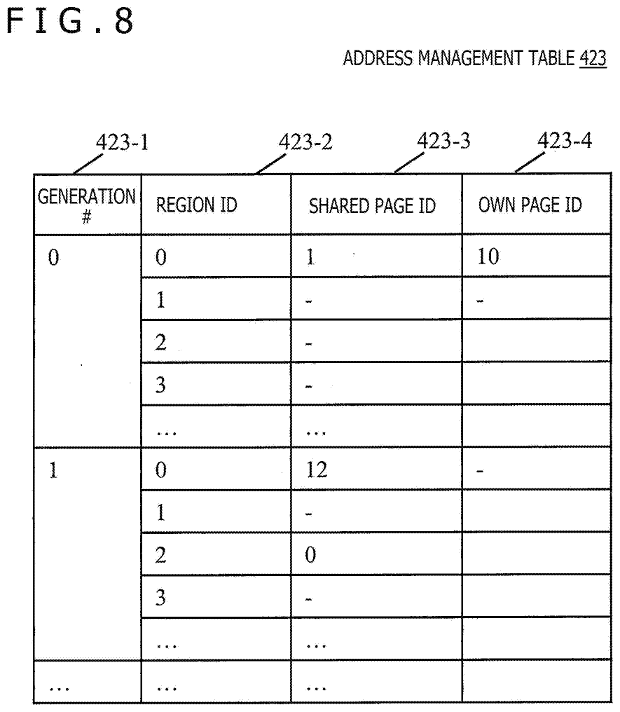

FIG. 8 is a diagram illustrating an example of the address management table 423, which lists information on each region of a snapshot of each generation. The address management table 423 manages records that are associated with a generation number (generation #) 423-1, a region ID 423-2, a shared page ID 423-3, and an own page ID 423-4.

The generation #423-1 is a number that uniquely identifies the generation of a PVOL snapshot in the storage system 300. The region ID 423-2 is a number identifying a PVOL region demarcated with respect to a snapshot of a generation number, and the same information as the region ID 422-2 depicted in FIG. 7. The shared page ID 423-3 is a number identifying a shared page where data in an associated region is to be stored. The shared page may be referenced by a different generation. The own page ID 423-4 is a number identifying an own page where data in an associated region is to be stored. The own page is referenced only by an associated generation. More specifically, an associated SVOL manages a snapshot of a generation that permits a write. The own page stores data in a case where the associated SVOL is written into. For example, the uppermost record in FIG. 8 indicates that region #0 of snapshot data of generation #0 has a shared page ID of 1 and an own page ID of 10.

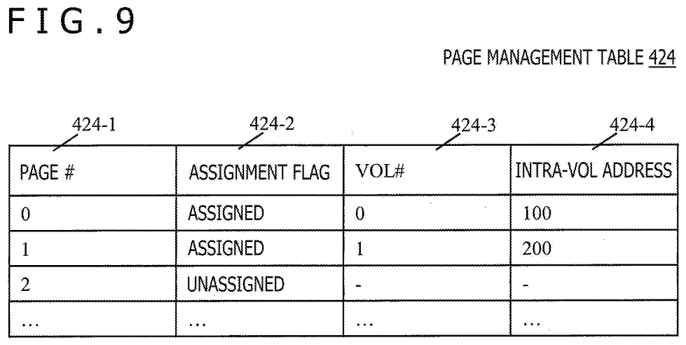

FIG. 9 is a diagram illustrating an example of the page management table 424, which lists information for pool address management. The page management table 424 manages records that are associated with a page number (page #) 424-1, an assignment flag 424-2, a VOL number (VOL #) 424-3, and an intra-VOL address 424-4. The page # 424-1 is a number that uniquely identifies a page 610 in the pool 503. The assignment flag 424-2 represents the state of the target page 610, that is, indicates whether the target page 610 is in an “assigned” state or in an “unassigned” state. The VOL #424-3 represents the number of an assignment destination VOL (PVOL or SVOL) to which the target page 610 is assigned. The intra-VOL address 424-4 is an address of the assignment destination VOL to which the target page 610 is assigned.

Some processes performed in the first embodiment will now be described.

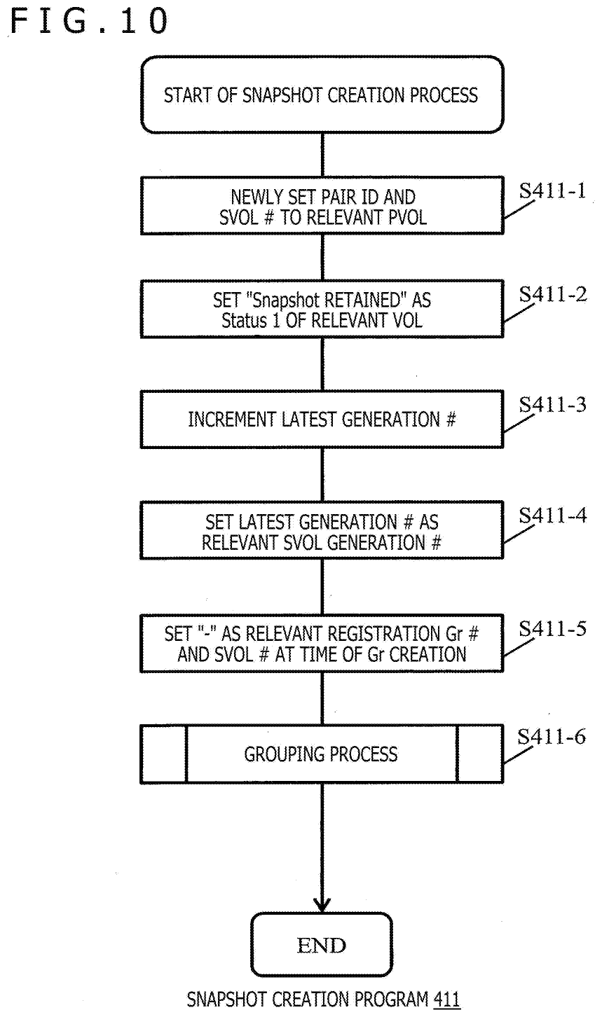

FIG. 10 is a flowchart illustrating a snapshot creation process. The snapshot creation process is performed from the server system 302 or the management system 308 at a preset time or upon receipt of a snapshot creation request. The snapshot creation program adds a new line to the pair management table 421 and newly sets a pair ID 421-3 and an SVOL #421-3 (step S411-1). SVOL creation is not always required for snapshot creation. In a case where SVOL creation is to be skipped, it is not necessary to perform step S411-1 of the snapshot creation program 411.

The snapshot creation program sets “snapshot retained” as status 1 (421-6) of the line in which the pair ID 421-3 and the SVOL #421-3 are newly set (step S411-2). Further, the snapshot creation program registers “uninstructed” in status 2 (421-7) to indicate that a snapshot deletion instruction is not issued.

The snapshot creation program increments the latest generation #421-2 of an associated PVOL in the pair management table 421 (step S411-3).

After the latest generation # is incremented, the snapshot creation program sets the latest generation # to the generation #421-5 of a snapshot creation target SVOL (step S411-4).

The snapshot creation program sets “−” to the registration Gr #421-9 of the creation target SVOL and the SVOL #421-10 at the time of Gr creation (step S411-5).

After completion of step S411-5, the snapshot creation program 411 performs the grouping process (step S411-6).

FIG. 11 is a flowchart illustrating the grouping process. If there is a snapshot of another administrator at the time of snapshot acquisition by the application 303, a grouping processing program 411-6 performs grouping. In a case where the management system 308 acquires a snapshot, the grouping processing program 411-6 also performs grouping as far as there is a snapshot of another administrator.

The grouping processing program 411-6 references the pair management table 421 (step S411-6-1). The grouping processing program 411-6 is a part of the snapshot creation program 411. The grouping processing program 411-6 performs a determination process on all pairs having the same PVOL # (step S411-6-2). The grouping processing program 411-6 determines whether the attribute information 421-8 on a snapshot to be subjected to the determination process is the same as the attribute information 421-8 on the pairs involved in snapshot creation (step S411-6-3). If the two sets of attribute information 421-8 are identical with each other, it is determined that a snapshot is acquired by the same administrator. Meanwhile, if the two sets of attribute information 421-8 are different from each other, it is determined that the snapshot is acquired by different administrators.

If the result of determination in step S411-6-3 is false (“NO” at step S411-6-3), the grouping processing program 411-6 performs a second determination process (step S411-6-4). Meanwhile, if the result of determination in step S411-6-3 is true (“YES” at step S411-6-3), the grouping processing program 411-6 performs processing on the next pair.

The second determination process S411-6-4 is performed to determine whether status 2 (421-7) of a determination target pair is “uninstructed.”

If the result of determination in step S411-6-4 is true (“YES” at step S411-6-4), the grouping processing program 411-6 adds an unused Gr # to the registration Gr #421-9 of the determination target pair (step S411-6-5). Meanwhile, if the result of determination in step S411-6-4 is false (“NO” at step S411-6-4), the grouping processing program 411-6 performs processing on the next pair.

After completion of step S411-6-5, the grouping processing program 411-6 sets a target SVOL # as the SVOL #421-10 at the time of relevant Gr creation. This ensures that, when the restore process is performed, the SVOL #421-4 can also be restored to the SVOL # at the time of Gr generation created. More specifically, the SVOL #421-4 may be changed due to a pair operation performed by one administrator. However, the SVOL #421-10 at the time of Gr generation remains the same as the number assigned at the time of group creation. Therefore, administrator 1 and administrator 2 are both able to reference a correct backup image.

In a case where no SVOL is created, the generation #421-5 at the time of Gr creation is recorded in the pair management table 421. In such a case, information on the generation # at the time of Gr creation is added to the pair management table 421, and a process of setting a target generation # as the generation # at the time of relevant Gr creation is added as a process subsequent to step S411-6-6 is performed by the grouping processing program 411-6.

Upon performing processing on all pairs having same PVOL #, the grouping processing program concludes the grouping process.

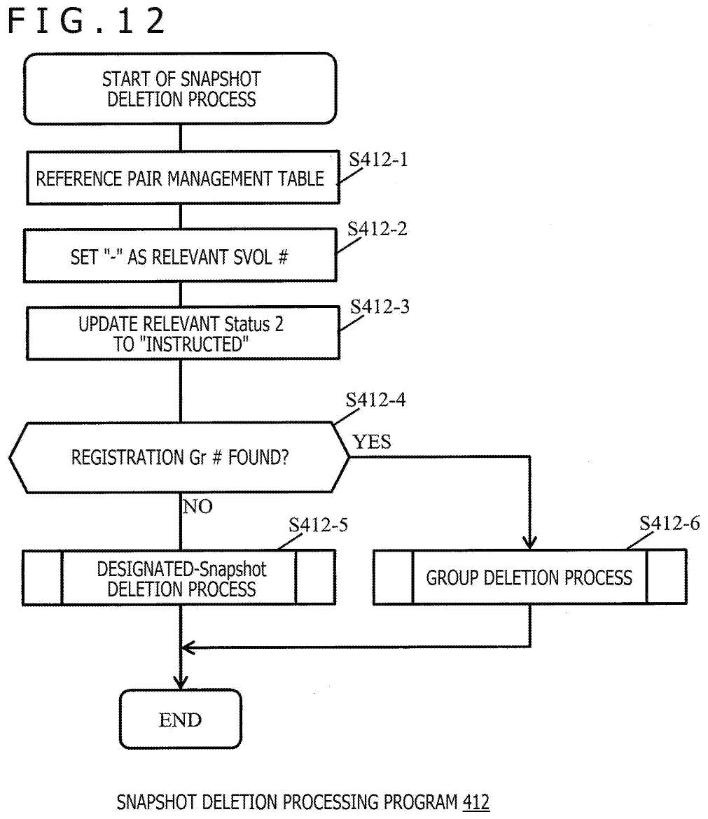

FIG. 12 is a flowchart illustrating a snapshot deletion process. As is the case with the snapshot creation process 411, the snapshot deletion process 412 is performed from the server system 302 or the management system 308 at a preset time or upon receipt of a snapshot deletion request.

The snapshot deletion program 412 references the pair management table 421 (step S412-1). The snapshot deletion program 412 sets “−” as the SVOL #421-4 of a snapshot deletion target pair. This ensures that a relevant SVOL # can be used even when an instruction for creating a snapshot with respect to a deleted SVOL # is received from the server system 302 or the management system 308.

When a snapshot is to be deleted, the presence of an SVOT is not a prerequisite. In a case where there is no SVOT, step S412-2 in the snapshot deletion process 412 need not be performed. When there is no SVOT, the generation #421-5 serves as the SVOL #421-4. Therefore, the relevant generation #421-5 is set to “−.”

After completion of step S412-2, “instructed” is set as status 2 (421-7) of the snapshot deletion target pair (step S412-3). After completion of step S412-3, a check is performed to determine whether the pair designed by the snapshot deletion request is grouped, that is, a relevant Gr # is registered as a registration Gr #421-9 in relevant pair management information (step S412-4). Group registration, that is, grouping, is performed based on the attribute information 421-8 and status 2 421-7. Therefore, a determination can be made directly based on the attribute information 421-8 and status 2 421-7.

If the result of determination in step S412-4 is false (“NO” at step S412-4), the pair designated by the snapshot deletion request is not grouped, that is, the pair is not used by any interface having attribute information 421-8 different from the attribute information 421-8 on the snapshot deletion target pair. Therefore, a designated-snapshot deletion process (step S412-5) is performed to actually delete snapshot data.

Meanwhile, if the result of determination in step S412-4 is true (“YES” at step S412-4), a group deletion process (step S412-6) is performed to determine whether the pair designated by the snapshot deletion request may be deleted, that is, an associated group is deletable. This ensures that, in an environment where a plurality of administrators use a snapshot function with respect to the same primary volume, the snapshot function can be used without affecting the operation of one administrator even in a case where another administrator performs a pair operation such as snapshot deletion.

The snapshot deletion process is completed upon completion of the designated-snapshot deletion process S412-5 or the group deletion process S412-6.

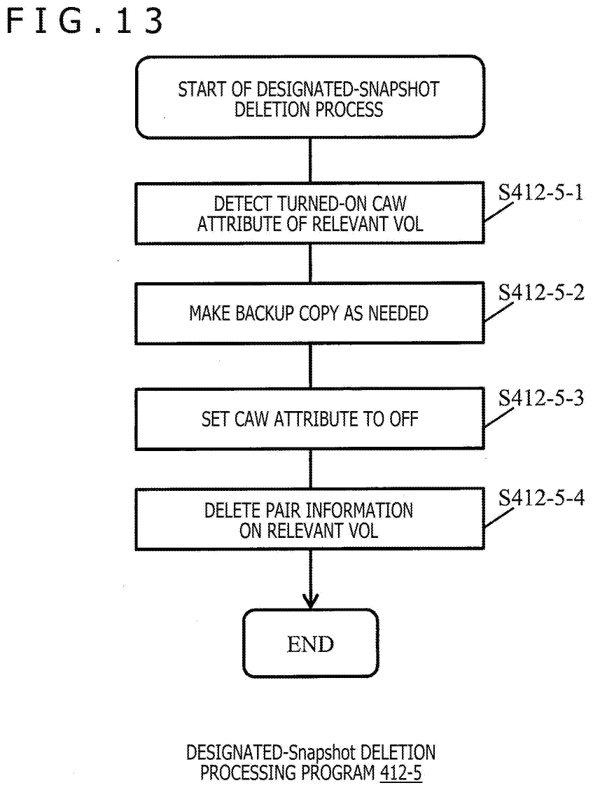

FIG. 13 is a flowchart illustrating the designated-snapshot deletion process. A designated-snapshot deletion processing program 412-5 is a part of the snapshot deletion program 412. The designated-snapshot deletion processing program 412-5 checks the difference region management table 422 to detect a region where the CAW attribute 422-5 is ON for a PVOL associated with an SVOL targeted for snapshot deletion (step S412-5-1). Subsequently, the designated-snapshot deletion processing program 412-5 makes, as needed, a backup copy of the region where the relevant CAW attribute 422-5 is ON (step S412-5-2). More specifically, data in a region that stores the SVOL to be deleted and is referenced by another snapshot is backup-copied into a referenced SVOL region.

Subsequently, as regards a saved PVOL region, the designated-snapshot deletion processing program 412-5 sets the CAW attribute 422-5 in the difference region management table 422 to OFF (step S412-5-3), and deletes the associated pair information from the pair management table 422 (step S412-5-4).

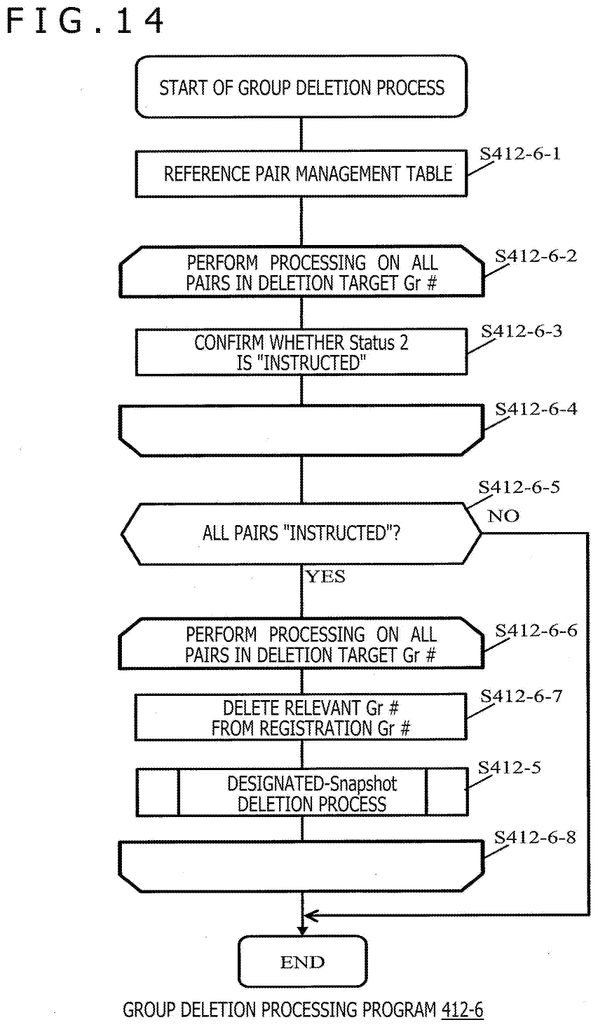

FIG. 14 is a flowchart illustrating the group deletion process. A group deletion processing program 412-6 references the pair management table 421 (step S412-6-1). The group deletion processing program 412-6 is a part of the snapshot deletion program 412.

The group deletion processing program 412-6 confirms whether status 2 (421-7) of every pair in a deletion target group is “instructed,” that is, instructed to be deleted (step S412-6-3), and determines whether status 2 (421-7) of every pair in the deletion target group is “instructed” (step S412-6-5).

If the result of determination in step S412-6-5 is true (“YES” at step S412-6-5), the group deletion processing program 412-6 deletes a deletion target group number from the registration Gr #421-9 of all pairs belonging to the deletion target group and performs the designated-snapshot deletion process (step S412-5).

Meanwhile, if the result of determination in step S412-6-5 is false (“NO” at step S412-6-5), the group deletion processing program 412-6 terminates the process without deleting a group. This prevents the problem described with reference to FIGS. 4A to 4D, that is, prevents a necessary snapshot from being deleted.

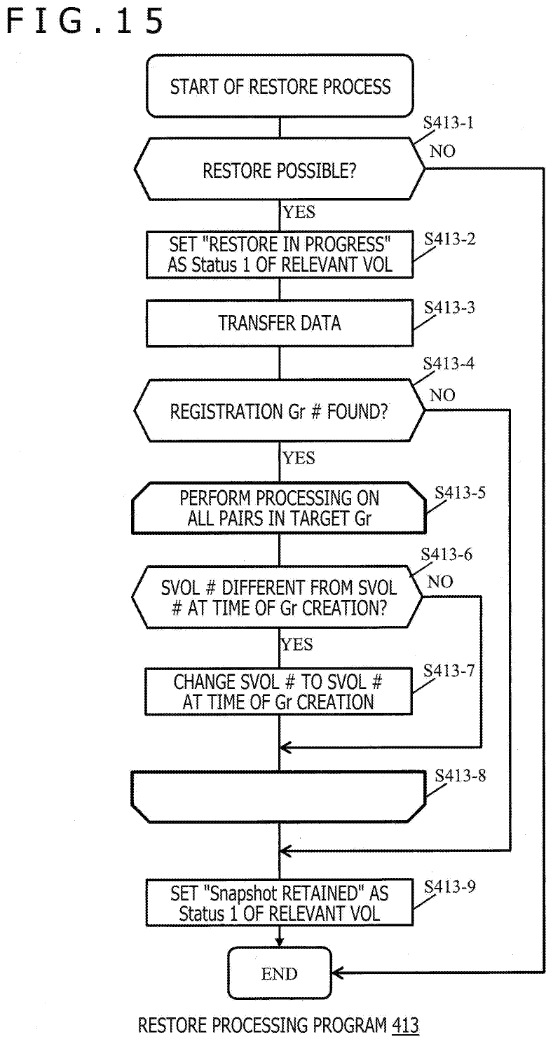

FIG. 15 is a flowchart illustrating the restore process. A restore processing program 413 is executed when a restore instruction with respect to an SVOL of a certain generation is issued from the server system 302 or the management system 308. When the restore process is to be performed, the presence of an SVOT is not a prerequisite. In a case where there is no SVOT, the restore instruction is issued with respect to a PVOL of a certain generation.

First of all, the restore processing program 413 determines whether a restore can be performed (step S413-1). For example, in a case where another SVOL is being restored with respect to the same PVOL, the restore process terminates as the restore cannot be performed. Further, in a case where a restorable SVOL is limited to an SVOL having the same attribute information as a restore operation interface, the restore processing program 413 determines whether the attribute information 421-8 on a restore target SVOL coincides with the attribute information 421-8 on the restore operation interface.

If the result of determination in step S413-1 is true (“YES” at step 413-1), the restore processing program 413 sets “restore in progress” as status 1 (421-6) of a relevant SVOL (step S413-2), and transfers data from the SVOL to a PVOL (step S413-3).

After completion of step S413-3, the restore processing program 413 determines whether the restore target SVOL is grouped (step S413-4).

If the result of determination in step S413-4 is true (“YES” at step S413-4), the restore processing program 413 performs a process of changing the SVOL # 421-4 of a group to which the restore target SVOL belongs (step S413-7).

Meanwhile, if the result of determination in step S413-4 is false (“NO” at step S413-4), the restore processing program 413 sets “snapshot retained” as status 1 (421-6) of the restore target SVOL (step S413-9), and then concludes the restore process.

In step S413-7, processing is performed to change the SVOL #421-4 of the group to which the restore target SVOL belongs. All pairs in a target group are checked to determine whether the SVOL #421-4 is different from the SVOL # at the time of group creation.

If the result of determination in step S413-6 is true (“YES” at step S413-6), the restore processing program 413 changes the relevant SVOL #421-4 to the SVOL #421-10 at the time of Gr creation (step S413-7). As the SVOL number at the time of group creation is restored, the restore instruction can be issued in a state at the time of snapshot creation irrespective of a snapshot operation performed by administrator 1 or 2 after group creation.

Meanwhile, if the result of determination in step S413-6 is false (“NO” at step S413-6), the restore processing program 413 performs processing on the next pair in the same group.

Upon completion of the process of changing the SVOL #421-4 in the target group, the restore processing program 413 sets “snapshot retained” as status 1 (421-6) of the restore target SVOL (step S413-9), and then concludes the restore process.

In a case where there is no SVOL, the SVOL #421-4 serves as the generation #421-5. Therefore, a check is performed in step S413-6 to determine whether the generation #421-5 is different from the generation # at the time of Gr creation. Likewise, in step S413-7, the generation #421-5 is changed to the generation # at the time of Gr creation.

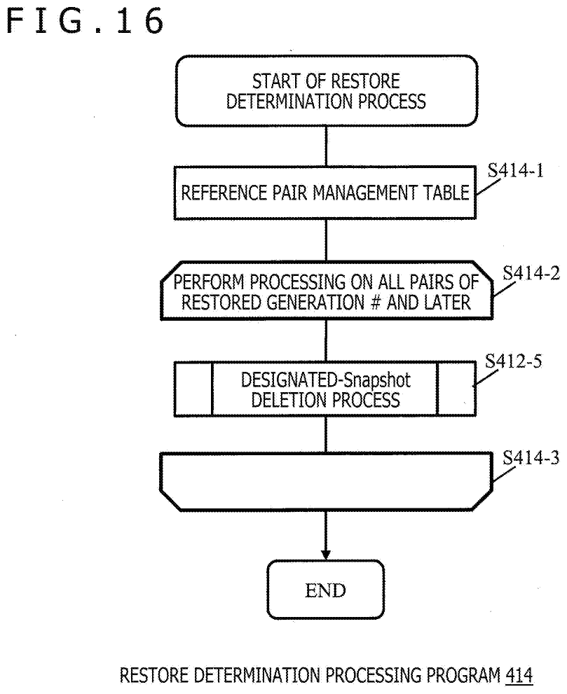

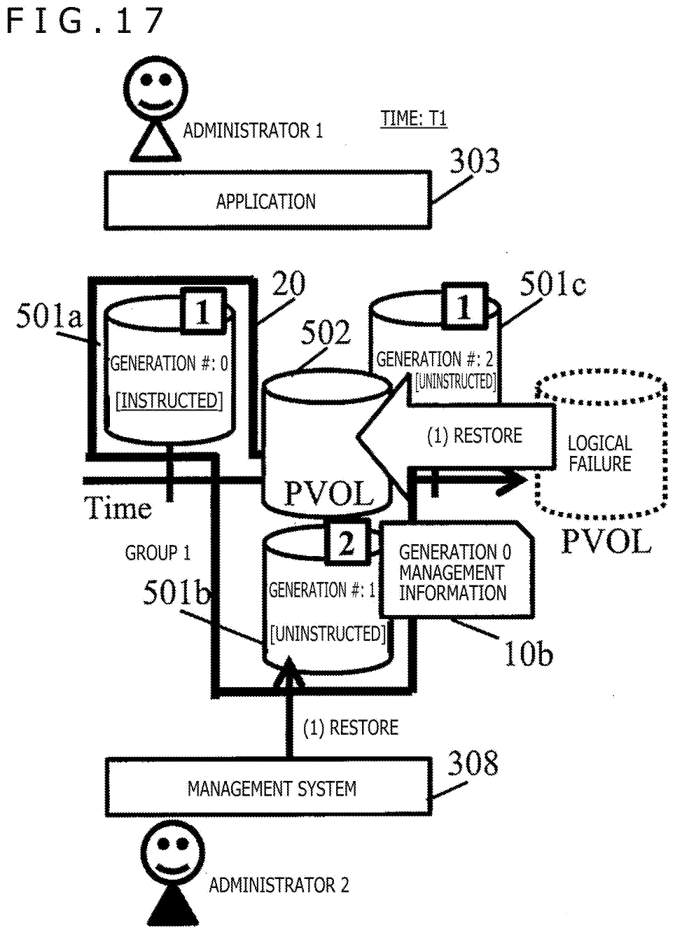

FIG. 16 is a flowchart illustrating a restore determination process. A restore determination processing program 414 is executed when the restored generation # is to be determined after the restore process 413. The restore determination process 414 is performed to avoid a situation depicted in FIG. 17. FIG. 17 is a conceptual diagram illustrating a snapshot processing method for the restore according to the first embodiment. After the restore is performed at time T1, the SS management information 10 used by the application 303 in the PVOL 502 is restored to a time point of generation #1. Therefore, only the information of generation #0 is recorded as the SS management information 10b. As a result, the application 303 is unable to recognize a snapshot of generation #2. Consequently, processing needs to be performed after a restore is performed with respect to generation #2. In the first embodiment, the restore determination process 414 deletes generation #2 (501a).

The restore determination processing program 414 references the pair management table 421 (step S414-1).

The restore determination processing program 414 uses the designated-snapshot deletion process S412-5 to delete all generations created subsequently to the restored generation #. This makes it possible to reduce the amount of pool consumption by deleting snapshot data of generations unrecognizable by the application 303.

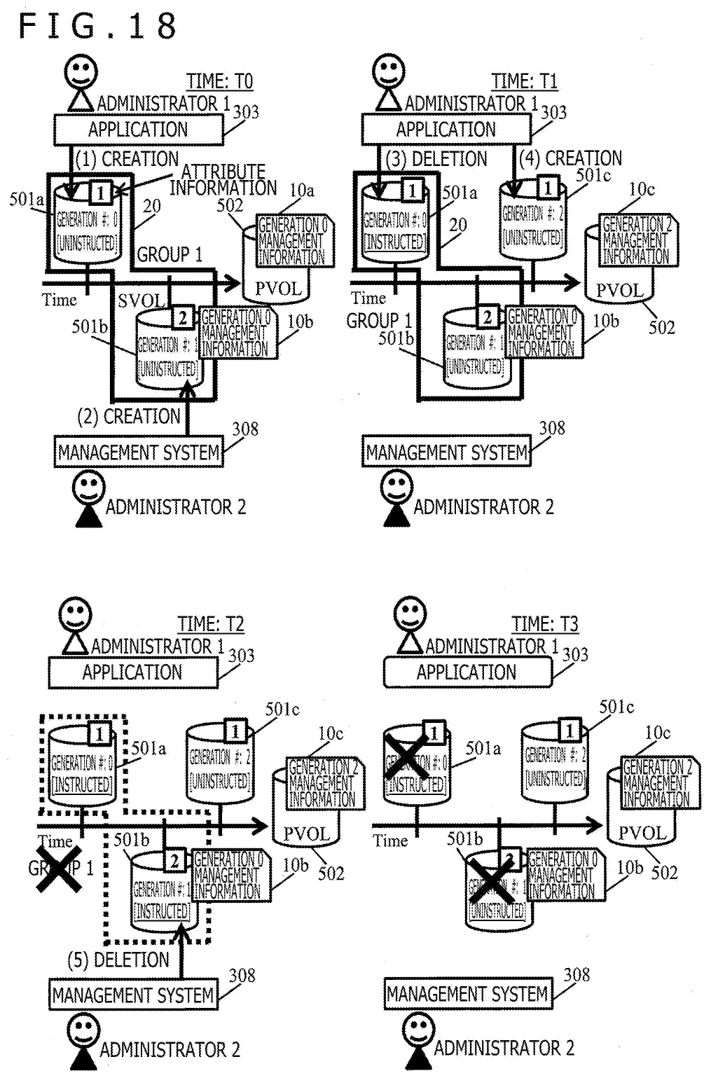

FIG. 18 is a conceptual diagram illustrating the above-described first embodiment of the present invention. For the sake of simplicity of explanation, it is assumed that the grouping process is performed only when a snapshot creation instruction is issued from the management system 308. When administrator 1 issues a snapshot creation instruction from the application 303 at time T0, the SVOL 501a, which is a snapshot of generation #0, is created. In such an instance, the attribute information and the “uninstructed” state, which indicates that a snapshot is still not instructed to be deleted, are recorded as the generation information described with reference to FIG. 6.

After completion of snapshot creation, the application 303 records the SS management information 10a of generation #0 in the PVOL 502. Subsequently, when administrator 2 issues a snapshot creation instruction from the management system 308, the SVOL 501b, which is a snapshot of generation #1, is created. As regards the SVOL 501b, an image including the management information of generation #0 is created. After completion of the snapshot creation process, the grouping process described with reference to FIG. 11 is performed. In a case where attribute information different from the attribute information on the created snapshot is recorded and a snapshot in the “uninstructed” state exists, the created snapshot and the snapshot in the “uninstructed” state are registered in the same group. That is to say, grouping is performed in a case where a snapshot creation instruction for creating a snapshot is issued by one administrator (administrator 2) and a snapshot created by another administrator (administrator 1) exists in the same volume as the snapshot designated by the snapshot creation instruction.

When administrator 1 issues, at time T1, from the application 303, a deletion instruction for deleting a snapshot of generation #0, the state of the snapshot of generation #0 is changed to “instructed,” which indicates that a deletion instruction is issued, in response to the received deletion instruction. A time point at which the snapshot is actually deleted is determined by the snapshot deletion program described with reference to FIG. 12, and snapshot deletion is performed asynchronously when later-described conditions are satisfied.

Accordingly, as depicted in FIG. 17, inconsistency does not occur even when administrator 2 performs a restore from the management system 308. As a result, it is possible to avoid a situation caused by the problem described with reference to FIGS. 4A to 4D.

Consequently, even when a plurality of users use the snapshot function with respect to the same primary volume, the snapshot function can be used without allowing a snapshot operation of any user to affect the operation of another user.

Subsequently, when administrator 2 issues, at time T2, from the management system 308, a deletion instruction for deleting a snapshot of generation #1, the state of the snapshot of generation #1 is changed to “instructed,” as is the case at time T1. In a case where all snapshots in group 1 are in the “instructed” state, the group deletion process described with reference to FIG. 14 is performed. Subsequently, as depicted in a drawing of time T3, only generations not used by any user can be deleted by deleting only the snapshots of generations that are in the “instructed” state and not grouped.

### Second Embodiment

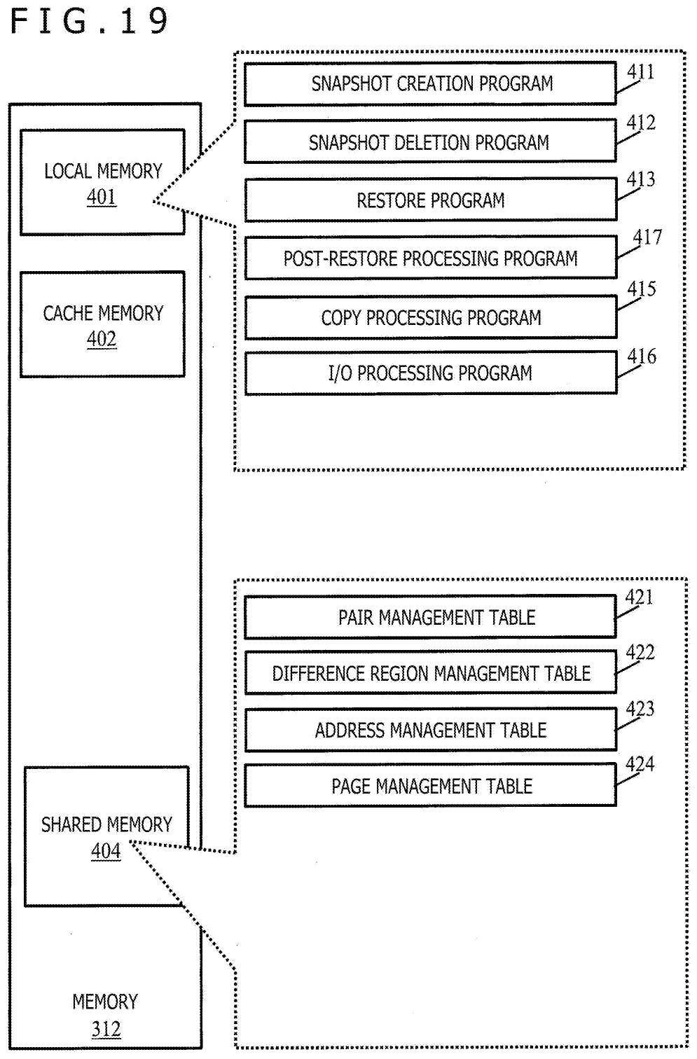

A second embodiment of the present invention will now be described with reference to FIGS. 19 to 21.

A method of allowing the restore determination processing program 414 to delete a snapshot of a generation unrecognizable by the application 303 in order to avoid the situation depicted in FIG. 17 has been described in conjunction with the first embodiment. Meanwhile, a method of automatically deleting a snapshot of a generation unrecognizable by the application 303 after a restore is described below in conjunction with the second embodiment.

FIG. 19 is a diagram illustrating an example configuration of the memory 312 and examples of programs and management information in the memory 312. A program configuration of the local memory 401 depicted in FIG. 19 is different from the program configuration of the local memory 401 depicted in FIG. 5.

The local memory 401 stores the snapshot creation program 411, the snapshot deletion program 412, the restore program 413, a post-restore processing program 417, the copy processing program 415, and the I/O processing program 416.

The cache memory 402 temporarily stores a data set that is to be written into or read from the PDEVs 320.

As is the case with the shared memory 404 depicted in FIG. 5, the shared memory 404 is used by both a processor 311 belonging to the same set as the memory 312 including the shared memory 404 and a processor 311 belonging to a different set. The shared memory 404 stores management information.

The management information includes the pair management table 421, the difference region management table 422, the address management table 423, and the page management table 424.

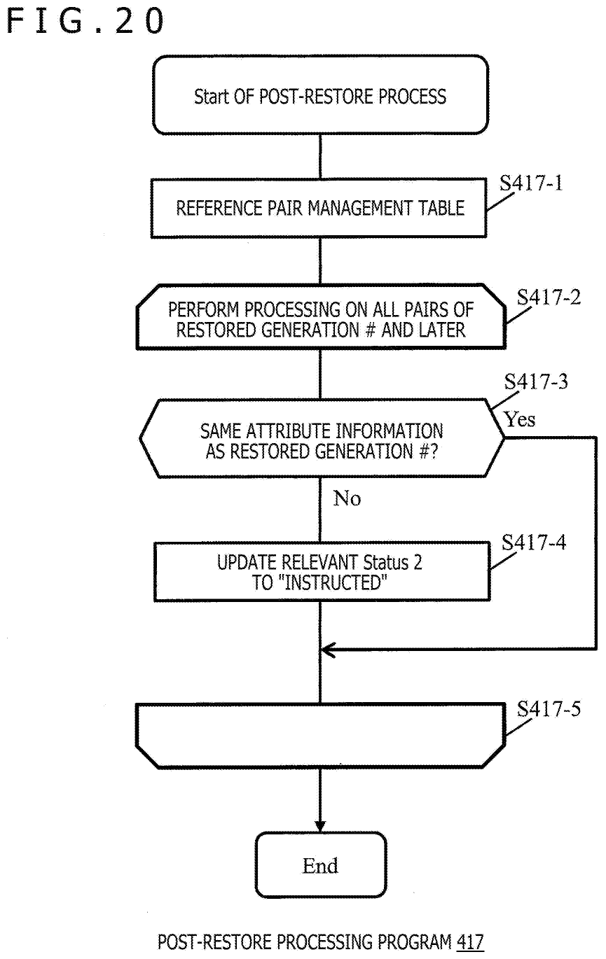

FIG. 20 is a flowchart illustrating a post-restore process. The post-restore processing program 417 references the pair management table 421 (step S417-1), and performs the following process on all pairs of a restored generation # and later generations.

The post-restore processing program 417 determines whether the attribute information 421-8 is the same as the attribute information on the restored generation (step S417-3).

If the result of determination in step S417-3 is true (“NO” at step S417-3), the post-restore processing program 417 updates status 2 (421-7) of a relevant pair management table to “instructed.”

If the result of determination in step S417-3 is false (“YES” at step S417-3), that is, a relevant pair has the same attribute information 421-8 as the attribute information on the restored generation #, a process of confirming the next pair is performed. When the determination process S417-3 is completed on all pairs of the restored generation # and later generations, the post-restore process 417 terminates.

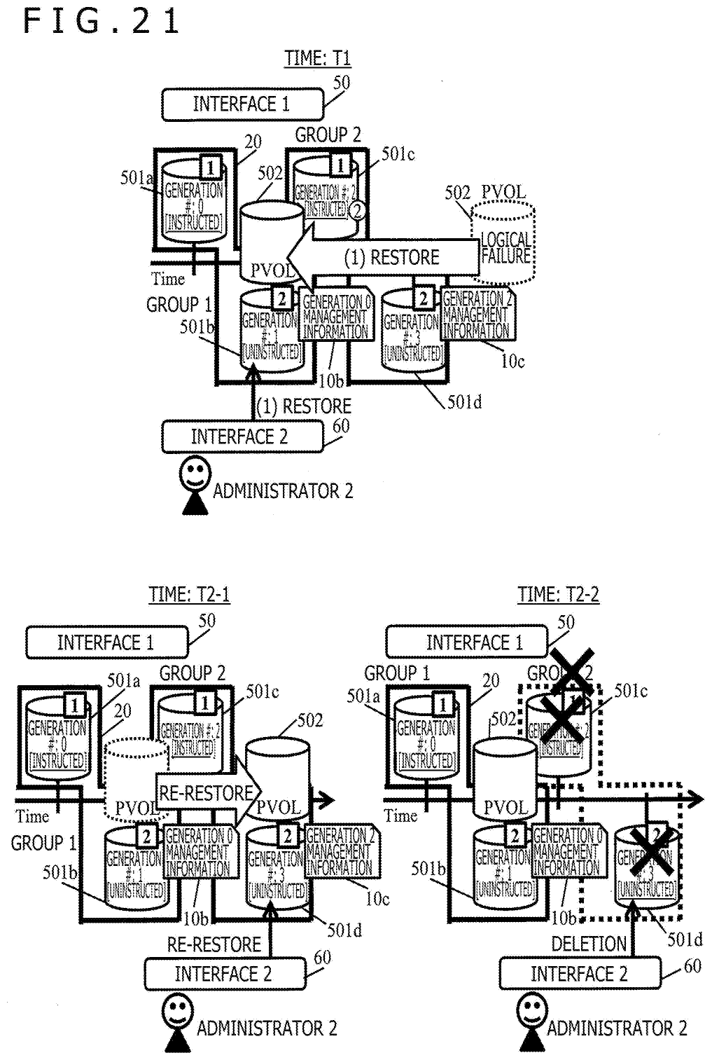

FIG. 21 is a diagram illustrating an operational concept of the post-restore process. The post-restore process is performed at time T1 to set “instructed” as status 2 (421-7) of an SVOL (501c) that is of a generation later than the restored generation and has attribute information 421-8 different from that on the restored generation. This ensures that, even if a re-restore is performed at time T2-1 from another SVOL, an SVOL (501a) required after the re-restore can be restored. Further, when an SVOL (501d) that need not be restored is deleted at time T2-2, the snapshot deletion process 412 achieves group deletion and snapshot deletion.

The present invention may also be implemented by various other embodiments. For example, in the foregoing embodiments, the transmission source (I/O source) of an I/O request such as a write request is the server system 302. Alternatively, however, the transmission source (I/O source) may be a non-depicted program in the storage system 300 (e.g., an application program to be executed on a VM).

What is claimed is:

1. A storage system comprising:
a storage device; and
a controller, wherein
the controller includes
a first interface connected to a server system that issues an IO request to the storage system,
a second interface connected to a management system that manages the storage system, and
a memory that provides the server system with a volume that is to be configured by using the storage device, and that stores attribute information and status information with respect to a snapshot to be acquired upon receiving a snapshot acquisition instruction on the volume from one of the first and second interfaces, the attribute information indicating whether the snapshot acquisition instruction is received through the first interface or the second interface, the status information indicating that an acquired snapshot is in a state where a deletion instruction is not issued yet.

2. The storage system according to claim 1, wherein
the snapshot acquisition instruction received through the first interface represents a request from the server system application, and
upon receiving a snapshot acquisition instruction from the application through the first interface, the controller stores snapshot management information in the volume.

3. The storage system according to claim 2, wherein
the status information stored in the memory includes information indicating that an acquired snapshot is in a state where a deletion instruction is received.

4. The storage system according to claim 3, wherein
when acquiring a plurality of snapshots in the volume that represent states at different time points, the controller performs group registration of the plurality of snapshots in accordance with the attribute information and the status information.

5. The storage system according to claim 4, wherein
when a deletion instruction for deleting one of the plurality of snapshots is received from one of the first and second interfaces and the snapshot designated by the deletion instruction is subjected to the group registration, the controller executes the received deletion instruction for snapshot only when the status information on all snapshots subjected to the group registration indicates a state where a deletion instruction is received.

6. The storage system according to claim 5, wherein
the controller sets the status information on all snapshots subjected to the group registration to a state where a deletion instruction is received, and then deletes the group registration.

7. The storage system according to claim 6, wherein
when the deletion instruction for snapshot designates a snapshot not subjected to the group registration, the controller deletes the snapshot.

8. The storage system according to claim 4, wherein
the controller causes the memory to store identification information on a snapshot subjected to the group registration that is recognizable by the server system at the time of the group registration.

9. The storage system according to claim 8, wherein
when restoring a snapshot subjected to the group registration, the controller restores the identification information recognizable by the server system.

10. The storage system according to claim 9, wherein
after a snapshot subjected to the group registration is restored, the controller deletes a snapshot of a generation unrecognizable by the server system.

11. A snapshot management method for a storage system including a storage device and a controller, wherein
the controller includes a first interface and a second interface, the first interface being connected to a server system that issues an IO request to the storage system, the second interface being connected to a management system that manages the storage system,
the controller provides the server system with a volume that is to be configured by using the storage device,
upon receiving a snapshot acquisition instruction on the volume from one of the first and second interfaces, the controller stores attribute information and status information with respect to a snapshot to be acquired, the attribute information indicating whether the snapshot acquisition instruction is received through the first interface or the second interface, the status information indicating that an acquired snapshot is in a state where a deletion instruction is not issued yet.
